(19) United States
(12) Patent Application Publication
(10) Pub. No.: US 2004/0059686 A1
(43) Pub. Date: Mar. 25, 2004

(54) On-line cryptographically based payment authorization method and apparatus

(76) Inventor: Daniel Robert Levesque, Monson, MA (US)

Correspondence Address: Daniel Levesque, 144 Palmer Road, Monson, MA, 01057, US

(21) Appl. No.: 10/251,700

(22) Filed: Sep. 19, 2002

(51) Int. Cl. G06F 17/60

(52) U.S. Cl. 705/71

(57) ABSTRACT

One aspect of this disclosure relates to a method for improving the security of authentication for client information in a payment system. The payment system may be applicable for credit card transactions such as may occur over the Internet or other networks. This is done with a system in which some of the client information currently required is not readily ascertainable to operators within the payment authorization system. In another aspect, a certificate is provided for use in a payment system. The payment system identifies an unknown person by the use of a private key and a public key. The private key is secretly held and is used to digitally sign and authenticate a payment using the public key. The payment system identifies the owner of the public key by the presentation of the digital signature from the private key and the public key. The certificate is an immutable form of the public key and identifying information. The certificate can be transferred from a consumer computer to a payment authorization server. The certificate can store a consumer numeric ID and a consumer encryption key. The payment authorization server can encrypt and decrypt payment information using the consumer encryption key. The payment authorization server can store a consumer numeric ID and encrypted payment information corresponding to the consumer numeric ID.

### FIELD OF THE INVENTION

This invention relates to payment authorization methods and devices, and more particularly to security aspects of payment authorization methods and devices.

### BACKGROUND OF THE INVENTION

The credit card system is a card based credit system. Credit cards are responsible for nearly 90% of all B2C e-commerce. A vendor can receive payment authorization for purchased merchandise without any physical monetary instruments being exchanged. Credit cards provide three essential requirements of Internet payments: disassociation of the sale and the payment, ubiquity, and consumer purchase protection.

The card in this system is the credential required to authorize a withdrawal from the associated credit or debit account. The card must be swiped through a card-swipe machine at the point of sale. The cardholder signature on a signature strip on the back of the card proves ownership of the card. A signature on the sales draft is checked at the point of sale to ensure that it matches the signature from the signature strip. Alternatively, a PIN number is used to prove ownership with many debit cards. Without a card-swipe and the cardholder's signature on the sales receipt, the vendor cannot prove a valid sale or force payment.

The current online credit/debit network is an Internet extension of the existing credit/debit network. As such, it provides vendors a way to authorize sales in real-time, and provides consumers the security of being able to refute a sale if merchandise is not delivered or is not as promised. Because of the rapid development and popularity of e-commerce, however, an online equivalent of the card-swipe and signature verification was not developed.

A sale involving a swiped card at the point of sale is called a card-present sale. The credit/debit card network will allow a sale without the presence of the card. A sale made without the card is called a card-not-present sale. Card-not-present sales include purchases made on the Internet, over the phone, or through the mail. Card-issuing banks, vendor processing banks, vendor processors, and the card brands limit their exposure to risk by declaring that card-not-present sales are high risk, and a conducted solely at the vendor's liability.

The Secure Sockets Layer transport protocol is used to secure the exchange of sensitive information on the Internet using an SSL-capable browser on a client and an SSL-enabled server. To SSL enable a server, the server owner purchases a certificate from a Certificate Authority (CA) which requires the owner to present documentation to prove that they own a particular Internet domain name. The Internet domain name is embedded in the certificate and cannot be altered. SSL is capable of 1.) encrypting communications between an unknown client and an unknown server, 2.) identifying basic information about unknown servers with reasonable certainty, and 3.) identifying basic information about unknown clients with reasonable certainty. It is not necessary to identify an unknown client or an unknown server to secure a communication, but a warning message will be displayed to the client if 1.) the client's SSL-capable browser does not recognize the CA who issued the certificate, 2.) the certificate has expired, or 3.) the domain name of the web page requested is not the same as the domain name on the certificate. Current prevalent online payment systems only employ SSL to identify with reasonable certainty the owner of a domain name and to secure the exchange of sensitive information between the client and the server. All websites that use SSL this way claim that they offer secure online payments even though they do not use SSL to identify clients with reasonable certainty. Such claims are dubious since the identity of the client is uncertain.

It is therefore desired to provide an improved system that a.) establishes certainty about the identity of each cardholder in payment authorization servers; b.) stores confidential information such as a consumer encryption key in an immutable form; c.) stores encrypted payment information at the payment authorization server rather than unencrypted payment information; and d.) stores the encryption key for the encrypted payment information on a consumer computer in the payment device and not at the payment authorization server. Due to such encryption, the owner/operator of the payment authorization server does not have access to the payment information and the usefulness of stealing payment information from the payment authorization server is negated. Such encryption would improve the acceptance of the overall payment system for the banks, the consumers, and the vendors.

### SUMMARY OF THE INVENTION

This invention relates to a method and associated system that authenticates each participant in a payment system. The payment system identifies an unknown person by the use of a private key and a public key. The private key is secretly held and is used to digitally sign and authenticate a payment using the public key. The payment system identifies the owner of the public key by the presentation of the digital signature from the private key and the public key. The certificate is an immutable form of the public key and identifying information. The certificate can be transferred from a consumer computer to a payment authorization server. The certificate can store a consumer numeric ID and a consumer encryption key. The payment authorization server can store the consumer numeric ID and encrypted payment information corresponding to the consumer numeric ID, and can encrypt and decrypt payment information using the consumer encryption key.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain features of the invention.

FIG. 1 is a schematic block diagram of one embodiment of payment system;

FIG. 2 is a flow diagram of one embodiment of payment authorization method that is performed by the payment system of FIG. 1;

FIG. 3 is a flow diagram of one embodiment of a new user set-up method of the payment authorization method shown in FIG. 2;

FIG. 4 is a flow diagram of one embodiment of an account set-up method of the payment authorization method shown in FIG. 2;

FIG. 5 is a flow diagram of one embodiment of a payment authorization server of the payment authorization method shown in FIG. 2;

FIG. 6 is a schematic block diagram of a traditional certificate complying with the X.509 standard;

FIG. 7 is a schematic block diagram of a payment authorization certificate used in one embodiment of the payment system of FIG. 1;

FIG. 8 is a diagram of the steps of server authentication by a client in a public key infrastructure; and

FIG. 9 is a diagram of the steps of client authentication by a server in a public key infrastructure.

The embodiments of the present invention are described hereto with reference to the accompanying drawings. The same or similar devices are represented by the same reference numerals in different ones of the figures.

### DETAILED DESCRIPTION OF THE EMBODIMENT

This disclosure describes multiple embodiments of a payment system 100 that can be used to authenticate a payment. The payment system 100 includes a consumer computer 102 and a payment authorization server 104. During operation, the payment authorization server 104 maintains an encrypted form of sensitive information possessed by the owner of consumer computer 102. Using encryption/decryption techniques, the owner of the consumer computer 102 can transmit information to the payment authorization server 104 and decrypt encrypted payment information, therefore authenticating the owner of the consumer computer 102 to the payment authorization server 104. No operator of the payment authorization server 104 has direct access to the sensitive information located on consumer computer 102.

One embodiment of a networked configuration is described that can operate as the payment system. Certain embodiments of cryptography, encryption, and decryption concepts (e.g. PKI and SSL) that relate to payment system 100 are described. Also, payment methods that can provide a payment function between the consumer computer 102 and the payment authorization server 104 are described.

I. Payment System Network Configuration

This section describes certain components forming a computer network that create embodiments of the payment system 100. FIG. 1 illustrates a block diagram of one embodiment of the payment system 100 that limits unauthorized payments to hackers, fraudsters, and the like. The payment system 100 relies upon the Public Key Infrastructure (PKI) to identify unknown parties such as a customer or client to the operator of the payment system. PKI is already a well-known and ubiquitous cryptographic protocol. There is no need for the payment system 100 to have an infrastructure conversion to attain immediate acceptance.

The payment system 100 functionally relies upon the client-server model that is generally known in computer networking. The client function corresponds to consumer computer 102. The payment system 100 performs one embodiment of payment authorization method 200 that includes a new user method 202, a new account method 204, and a payment authorization method 206, as described below. The server function is specific to the particular payment authorization method. For the new user method 202, the server is the trusted CA 118. For the new payment account method 204, the servers are trusted source 106 and payment authorization server 104. For payment authorization method 206, the server is the payment authorization server 104.

The embodiment of payment system 100 shown in FIG. 1 includes the consumer computer 102, the payment authorization server 104, the trusted CA (or trusted CA server) 118, a trusted source (or trusted source server) 106, and a network 105. The consumer computer 102, generally owned and operated by a retailer or consumer, is a general-purpose computer that contains networking software. The consumer computer 102 permits a consumer to prove payment account ownership to the payment authorization server 104. Alternatively, the consumer computer 102 may be a specific purpose computer including, e.g., an application specific integrated circuit, designed to prove payment account ownership to the payment authorization server 104. The trusted source 106 and the trusted CA 118 are computer-based devices such as servers. The trusted source 106 provides the initial confirmation of the consumer's payment account ownership to the payment authorization server 104. The trusted CA 118 provides the signed payment authorization certificate 700 that establishes trust between the consumer computer 102 and the payment authorization server 104.

As a networked system, certain components of the payment authorization server 104, the consumer computer 102, the trusted CA 118, and the trusted source 106 interface with each other based on the networking client-server model. A microprocessor 108, a CPU 110, a memory 112, an input/output device (I/O) 114, and a support circuit 116 are collectively referenced (in the plural) by appending the letters “a”, “b”, c and “d” depending upon whether each one of the elements 108, 110, 112, 114, or 116 are within the consumer computer 102, the payment authorization server 104, the trusted CA 118, or the trusted source 106.

The respective memories 112a to 112d each store the routines performed by the microprocessors 108a to 108d. The support circuits 116a to 116d include, e.g. power supplies, clock circuits, cache and the like. The software implementation 120 of the methods of the present invention are stored within the respective memories 112a to 112d and are executed by the respective microprocessors 108a to 108d to facilitate control of the payment system 100. The microprocessors 108a to 108d, the CPUs 110a to 110d, the memories 112a to 112d, the input/output devices (I/O) 114a to 114d, and the support circuits 116a to 116d are each illustrated respectively within the consumer computer 102, the payment authorization server 104, the trusted CA 118, and the trusted source 106. Due to the networked aspects of the payment system 100, the location that of particular data or instructions within the consumer computer 102, the payment authorization server 104, the trusted CA 118, the trusted source 106, or the network 105 during execution is uncertain.

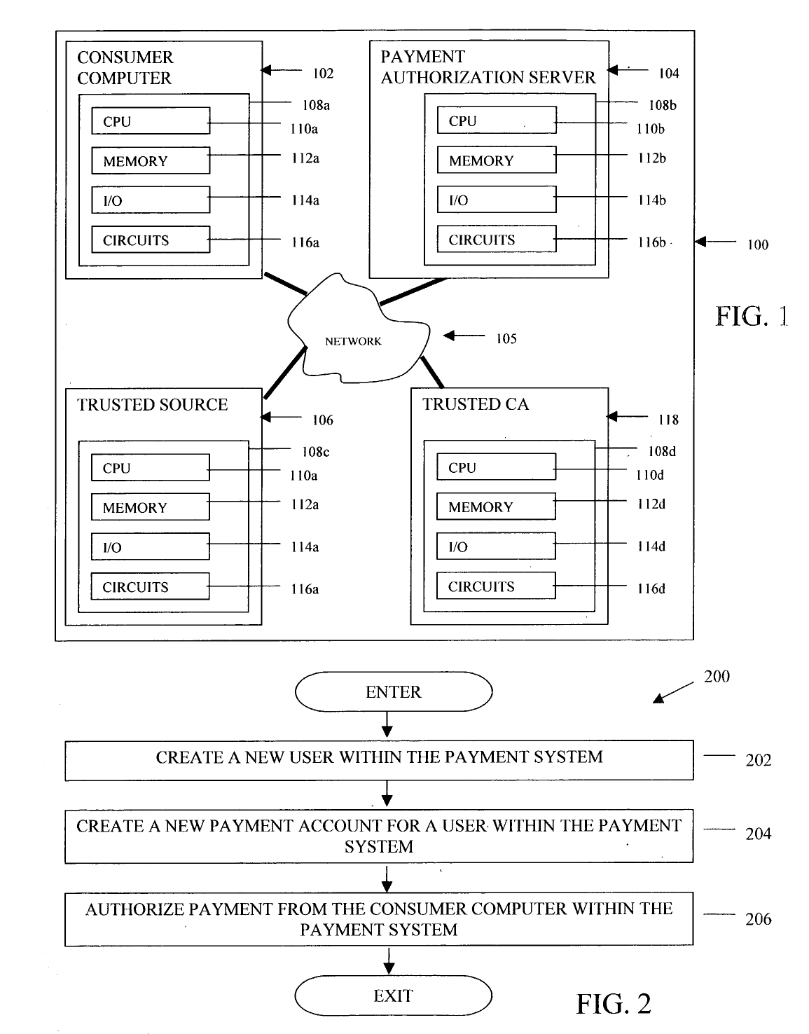

Although the methods performed by the consumer computer 102, the payment authorization server 104, the trusted CA 118, and the trusted source 106 are each depicted as general purpose computers that are programmed to perform the scheduling routines (such as illustrated in FIGS. 2 to 5), the invention can be implemented in hardware using, e.g., an application specific integrated circuit (ASIC). As such, software, hardware, or a combination thereof can equivalently perform the process steps. Additionally, the computer configuration with the payment system 100 can be modified from the embodiment shown in FIG. 1, as is generally known to those in the networking technologies, while remaining within the intended scope of the present invention.

II. Cryptography Concepts

This section describes the cryptography concepts and technologies associated with the payment system 100. Most particularly the application of symmetric and public key cryptography, a Public Key Infrastructure, SSL, and other related technologies and software in a preferred embodiment of the payment system 100.

Cryptography is a science that uses keys and codes to hide messages, and forms the basis for secure communications over the Internet. Written messages have been encrypted and decrypted since ancient times. An encryption algorithm (or cipher) is a specific method of using an encryption key on a message to produce an encrypted message. Internet message encryption algorithms must be both sophisticated and well proven to gain commercial acceptance. Any known weakness in the algorithm can be used to attack and decrypt encrypted messages. Public disclosure of such algorithms ensures adequate security of commonly used encryption algorithms which is necessary for such algorithms to gain acceptance. A cryptosystem is a system employing cryptography to encrypt and decrypt messages.

To indicate the numerical challenge of attacking a cryptographic message within a cryptosystem, consider an encryption algorithm that securely encrypts a message using an encryption key. Since there are approximately 31.54×10⁶ seconds in a year, if the most advanced supercomputers in the world can run through a billion runs of a decryption in a second, it still can only test 31.54×10¹⁵ keys in a year. There are a total of 62 uppercase letters, lowercase letters, and numeric digits. Using a password of 10 randomly generated characters from this limited set will produce 839.3×10¹⁵ different possible keys It will therefore take 26.6 years to guess all permutations of numbers and letters assuming that neither the password nor the computer is changed in that duration. Sophisticated passwords use bytes and not alphabetic characters for a set of 256 possible characters; resulting in 1.21×10²⁴ different possible keys, or 38.4 million years to run through all of the possible keys. This example of attempting to decrypt such a randomly generated key is called a Brute Force attack. Accepted encryption algorithms are resistant to brute force attacks.

Unfortunately, the encrypted message is only as strong as the encryption key. The use of non-random characters decreases the effectiveness of encryption schemes. For example, if a common word is used (or a common word with a single digit added to the end) the key is limited to about a couple of million possibilities, and can be broken rather quickly. Barring the use of common words, an attack on an encrypted message must concentrate on possible weaknesses in the encryption algorithm or how it is implemented on a piece of hardware.

A. Symmetric and Asymmetric Encryption Algorithm

An algorithm is an explicit description of how a particular computation should be performed (or how a problem is solved). The efficiency of an algorithm can be measured as the number of elementary steps it takes to solve the problem. Stating that an algorithm takes time O(n) then we mean that it takes n elementary steps, but does not indicate the duration of each step. Existing cryptography algorithms have two basic forms: symmetric encryption algorithms and asymmetric encryption algorithms. Certain embodiments of cryptography algorithm characteristics are described.

Symmetric encryption uses the same key (also called the encryption key) to encrypt and decrypt the message. Symmetric encryption (also called shared secret encryption) requires that both the encryptor and the decryptor know the key. Modern symmetric algorithms are sophisticated and allow quick operation. Symmetric algorithms that are currently applied to the Internet include RC2, RC4, DES, and 3DES. The National Institute of Standards and Technology (NIST) has recently selected the Rijndael (pronounced rain-doll) algorithm for its next generation symmetric encryption algorithm, called the Advanced Encryption Standard (AES).

Symmetric algorithms can be divided into two categories: stream ciphers and block ciphers. Stream ciphers can encrypt a single bit of plaintext at a time, whereas block ciphers take a number of bits (typically 64 bits in modem ciphers), and encrypt them as a single unit.

2B. Asymmetric Encryption, Including Public Key Encryption

This sub-section describes aspects of asymmetric encryption (also called public key encryption). Asymmetric encryption is encryption using two different, but related, keys to encrypt and decrypt a message. Asymmetric encryption involves a key pair (including one private key and one public key) for any particular key owner. The owner holds the private key in secret, but the owner can give access to the public key to anyone. Encrypting a message with a public key is an effective way to ensure that only the owner of the private key can decrypt and read the message. Anyone with access to the publicly available public key can send encrypted messages that can only be decrypted using the private key. Conversely, messages which are encrypted using the private key can only be decrypted using the public key. Since the public key is generally available to the public, encrypting a message with the private key (which can thus be decrypted with the public key) is not an effective means of encrypting a message. Instead, encrypting a small “bogus” message with a private key is used as a digital signature. Only the one owner of the private key could have produced the digital signature. Verification of the digital signature using the public key proves authorship of the message by the owner of the private key.

The basic ingredient in any public key cryptosystem is a difficult computational problem. The security of the cryptosystem presumes that the private key can be computed from the public key only by solving this difficult problem.

Modem asymmetric algorithms are complex and compute resource intensive. Only small messages can be encrypted and decrypted using asymmetric encryption due to the complexity of the process. Usually only a symmetric key and a hash value are encrypted using asymmetric encryption. The message itself is encrypted using symmetric key encryption.

2C. Computational Complexity

This sub-section describes the computational complexity associated with various algorithms involved with public key encryption and decryption schemes. A problem is considered in polynomial time (i.e. in P time) if the problem can be solved by an algorithm which takes less than O(n^{t}) steps, where t is some finite number and the variable n measures the size of the problem instance. If a guessed solution to a problem can be verified in polynomial time then the problem is said to be in NP (non-deterministic polynomial time). The set of problems that lie in NP is very large, it includes the problem of integer factorization.

It is NP-hard if there is no other problem in NP that is easier to solve. There is no known polynomial time algorithm for any NP-hard problem, and it is believed that such algorithms in fact do not exist.

In public key cryptography the attacker is interested in solving particular instances of a problem such as factoring some given number rather than providing a general solution such as providing an algorithm to factor any possible number efficiently. This causes some concern for cryptographers, as some instances of a problem that is NP-hard in general may be easily solvable.

2D. Primes and Factoring

A prime number is a number that has no divisors except for itself and 1. Thus the integers 2, 3, 5, 7, 11, . . . and so on are primes. There are infinitely many primes, and (one of) the biggest prime numbers currently known is (2^{6,972,593})−1. Every integer can be represented uniquely as a product of prime numbers. For example, 10=2*5 (the notation * is common for multiplication in computer science) and it is unique (except for the order of the factors 2 and 5). The art of factorization is almost as old as mathematics itself. However, the study of fast algorithms for factoring is only a few decades old.

One possible algorithm for factoring an integer is to divide the input by all small prime numbers iteratively until the remaining number is prime. This is efficient only for integers that are, say, of size less than 10¹⁶ as this already requires trying all primes up to 10⁸. In public key cryptosystems based on the problem of factoring, numbers are of size 10³⁰⁰ and this would require trying all primes up to 10¹⁵⁰ and there are about 10¹⁴⁷ such prime numbers according to the prime number theorem. This far exceeds the number of atoms in the universe, and is unlikely to be enumerated by any effort. In cryptography we want to use only those integers that have only large prime factors. Preferably we select an integer with two large prime factors, as is done in the RSA cryptosystem.

III. Public Key Cryptography and SSL

This section describes multiple embodiments of cryptography algorithms which relate to the payment system 100. Some of these cryptography concepts are standardized or contained in presently used cryptosystems.

3A. Public Key Infrastructure (PKI)

A public key infrastructure is the implementation of a trust based public key cryptosystem that employs immutable certificates to hold the public keys. PKI forms the basis for Secured Sockets Layer (SSL), as described below. Both PKI and SSL may be used by different embodiments of payment systems 100 as shown in FIG. 1, in a manner as described below. Recent Netscape Navigator and Internet Explorer browsers can participate in PKI's. All recent Microsoft Windows versions can participate in PKI's. The Internet is an efficient, inexpensive, globally available open network. PKI's are the technology of choice for identifying an unknown client over an open network such as the Internet. Corporate customers use PKI's to place and track orders and banks use PKI's to transfer funds.

Certificates are a public key container (or public key package) designed for open networks. The certificates contain the public key and additional identifying information of an entity or client. The certificate is immutable, and as such cannot be altered by others after issuance. A common certificate standard is the X.509 certificate. Standard fields contained in an X.509 certificate include: country, organization, organization unit, state or province name, common name (e.g. Susan Jones), and serial number. A recent and ubiquitous X.509 certificate standard is X.509 version 3. One embodiment of X.509 certificates referenced in this document refer explicitly to X.509 version 3 certificates. The X.509 certificate includes a field wherein a purpose can be included with the certificate. An X.509 certificate 600 as described below with a purpose of server authentication is used by payment authorization server 104 to prove its identity to consumer computer 102 and to allow an SSL connection between payment authorization server 104 and consumer computer 102. An X.509 payment authorization certificate 700 as described below with a purpose of client authentication is used by consumer computer 102 to prove its identity to payment authorization server 104.

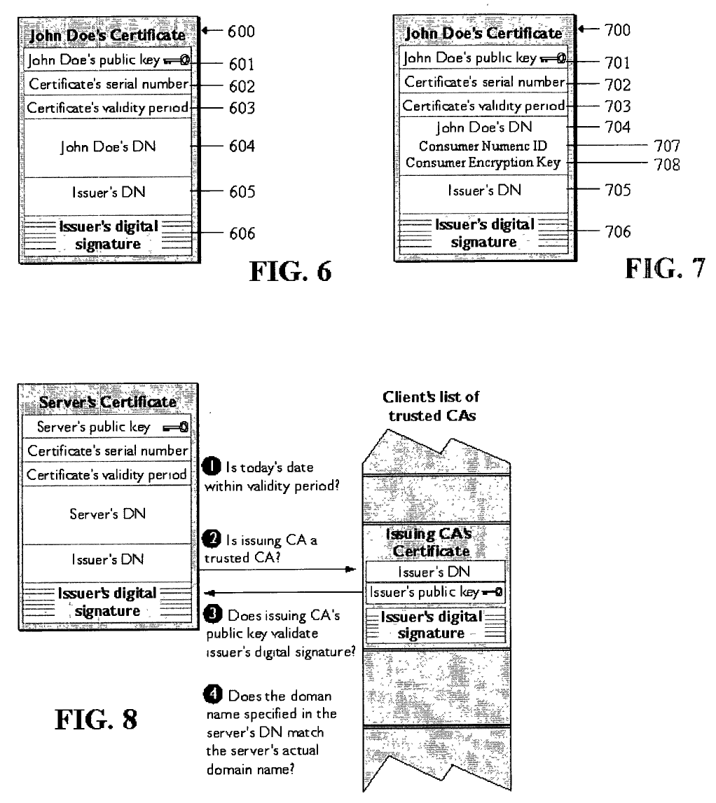

FIG. 6 shows the common types of information stored in a typical certificate 600 used for server or client authentication. One embodiment of the typical certificate 600 used in a payment system 100 referenced in this document refer explicitly to certificates used for server authentication. This information includes the public key 601, the certificate's serial number 602, the certificate's validity period 603, the distinguishing name (DN) of the certificate owner 604, the issuing CA's distinguishing name (Issuer's DN) 605, and the Issuing CA's digital signature 606. The certificate's DN 604 usually contains information such as the website domain name, organization that owns the organization, organization unit, state or province name, and country.

FIG. 7 shows the common types of information stored in a payment authorization certificate 700 stored on the consumer computer 102 for client authentication. The information stored in the payment authorization certificate 700 includes the consumer's public key 701, the certificate's serial number 702, the certificate' validity period 703, the consumer's distinguishing name (DN) 704, the issuing CA's distinguishing name (Issuer's DN) 705, and the Issuing CA's digital signature 706. The certificate DN 704 of the payment authorization certificate 700 does not contain personal information such as the consumer's name, etc. Instead, the certificate DN 704 contains a consumer numeric ID 707 and a consumer encryption key 708 in the standard fields which, together, may be considered as authentication identification information 712. The certificate DN 704 of the payment authorization certificate 700 may include other information such as consumer's nickname, consumer's state or province, consumer's country, product version number, and issuing company's name. The reader considering the description of FIG. 7 in this disclosure should view both FIGS. 1 and 7. The consumer numeric ID 707 is used to identify encrypted payment account information 122 owned by the consumer computer 102 that are stored at the payment authorization server 104. In certain embodiments of payment system 100, the consumer numeric ID 707 is alphanumeric, sequential, contains defining prefixes, and/or contains defining suffixes in some embodiments. The consumer encryption key 708 ensures payment account ownership because only the value of the consumer encryption key 708 can decrypt the corresponding payment accounts stored at the payment authorization server 104.

A PKI consists of at least one commonly trusted Certificate Authority such as the trusted CA 118. A root Certificate Authority (root CA) is a CA that is self-trusting. Its certificate is not signed by another CA. An intermediate Certificate Authority (intermediate CA) is a CA that has its certificate signed by another CA. There can be a hierarchy of CA's stemming from a root CA. As an example, a root CA issues a certificate to an intermediate CA. The intermediate CA makes the request for a certificate from the root CA because it trusts the root CA. Conversely, the root CA signs and issues the certificate to the intermediate CA once it establishes trust of the intermediate CA. The intermediate CA then issues a certificate to another intermediate CA once they have established mutual trust. The second intermediate CA then issues a certificate to a consumer computer (such as consumer computer 102) once they have established trust. Each issuing CA's signature becomes a part of each certificate they issue. These certificates, linked by the signatures of their issuing CA's that trust each other, are called the certificate chain (or certificate chain of trust).

Requests for certificates from a CA can come from other servers or from a browser on a client. Software on the requester generates a public-private key pair, incorporates the public key into the certificate request, and requests to have the CA sign the request with their private key. The CA signs and issues the certificate following approval of the certificate request. Following issuing the certificate, all parties can use the CA's public key to determine that the CA signed the certificate. Two unknown parties can present certificates issued by a mutually trusted root or intermediate CA as proof of their identity.

A hash algorithm (or one-way hash algorithm) is a numeric equivalent to a message. Good hash algorithms force small changes in a message to produce large changes in hash values. SHA-1 is a hash algorithms used on the Internet, and is well accepted and considered secure. By definition, the same message must always produce the same hash. Hashes test a message to ensure that the message has not changed. Hashes are commonly used in digital signatures. The hash value of a message is typically encrypted using the private key of the owner. The public key of the owner can then be used by any of the recipients to prove that the owner was the author of the message, and that the message is the same message that the owner authored (i.e. the hash value proves that the message has not changed).

3B. SSL (Secure Sockets Layer)

The SSL protocol uses a combination of public-key and symmetric-key encryption. Symmetric-key encryption is much faster than public-key encryption; however, public-key encryption is more widely applicable in a payment system. An SSL session always begins with an exchange of messages called the SSL handshake. The handshake allows the server to authenticate itself to the client by using public-key techniques, and then allows the client and the server to cooperate in the creation of symmetric keys used for rapid encryption, decryption, and tamper detection during the session that follows. Optionally, the handshake also allows the client to authenticate itself to the server. In the payment system 100, the client authentication of consumer computer 102 to payment authorization server 104 is required. SSL was originally developed as an open protocol standard by Netscape.

SSL is the most prevalent Internet security technology. SSL encrypts and decrypts information for transport over public, open networks like the Internet. Globally trusted CA's (global CA's) are the issuers of almost all of the typical certificates 600 used for SSL communications between websites and web browsers. In contrast, only the trusted CA's 118 of payment system 100 sign and issue payment authorization certificates 700. After a global CA verifies that the entity requesting the typical certificate 600 owns a domain name, the global CA issues the typical certificate 600 which includes the domain name. The global CA's function does not provide an indication that the requestor is not unscrupulous; just that they own the domain name for which they are requesting the typical certificate 600.

The steps of the SSL handshake with client authentication as used in payment system 100 are detailed here. The consumer computer 102 sends the payment authorization server 104 the SSL version number, acceptable symmetric encryption algorithms, session-specific data, and other information of the consumer computer 102 that the payment authorization server 104 needs to communicate with the consumer computer 102 using SSL. The payment authorization server 104 sends the consumer computer 102 the SSL version number, acceptable symmetric encryption algorithms, session-specific data, and other information of payment authorization server 104 that consumer computer 102 needs to communicate with payment authorization server 104 over SSL.

The payment authorization server 104 also sends its own typical certificate 600 and requests the payment authorization certificate 700 from the consumer computer 102. The consumer computer 102 uses the information sent by payment authorization server 104 to authenticate the payment authorization server 104.

FIG. 8 displays one embodiment of requirements for the typical certificate 600. The consumer computer 102 checks: 1.) whether today's date is within the validity period of payment authorization server 104's typical certificate 600; 2.) whether the CA that issued the payment authorization server 104's typical certificate 600 is on the list of CA's that the consumer computer 102 trusts; 3.) whether the issuing CA's public key that is stored in the consumer computer 102's list of trusted CA's validates the issuer's digital signature obtained from the payment authorization server's 104 typical certificate 600; 4.) whether the domain name specified in the payment authorization server 104's DN matches the payment authorization server's 104 actual domain name.

If the payment authorization server 104 cannot be authenticated, the user of the consumer computer 102 is warned of the problem. If the payment authorization server 104 can be successfully authenticated, the consumer computer 102 (with the cooperation of the payment authorization server 104, depending on the algorithm being used) creates the pre-master secret for the session, and encrypts it with the payment authorization server's 104 public key (obtained from the payment authorization server 104's typical certificate 600). The consumer computer 102 creates a one-way hash from data that is unique to this handshake and known by both the consumer computer 102 and the payment authorization server 104, encrypts the hash using the consumer computer's 102 private key (creating a digital signature) and sends the signed data, the payment authorization certificate 700, and the encrypted pre-master secret to the payment authorization server 104.

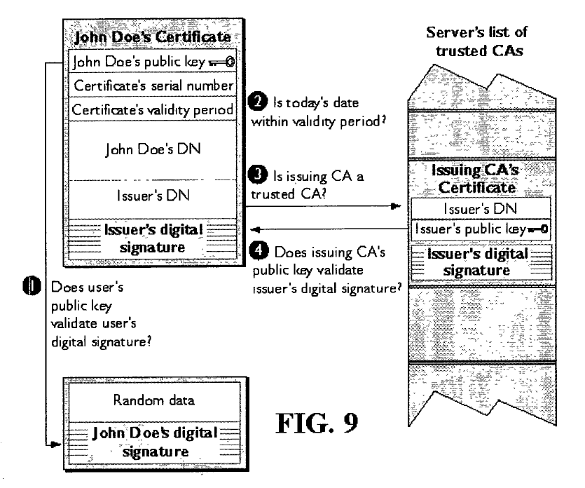

FIG. 9 shows what the requirements are for authenticating the consumer computer 102 at the payment authorization server 104. The payment authorization server 104 checks: 1.) whether the consumer computer's 102 public key from the payment authentication certificate 700 validates the transmitted digital signature; 2.) whether the current date is within the validity period of the payment authorization certificate 700; 3.) whether the CA that issued the payment authorization certificate 700 is on the list of the CA's that the payment authorization server 104 trusts (i.e. the trusted CA 118); and 4.) whether the issuing CA's public key that is stored in the payment authorization server's 104 list of trusted CA's validates the issuer's signature retrieved from the payment authorization certificate 700.

If the consumer computer 102 cannot be authenticated by the payment authorization server 104, the session ends. If the consumer computer 102 can be authenticated, the payment authorization server 104 uses its private key to decrypt the pre-master secret, and then performs a series of steps (which the consumer computer 102 also performs, starting from the same pre-master secret) to generate the master secret. Both the consumer computer 102 and the payment authorization server 104 use the master secret to generate the session keys, which are symmetric keys used to encrypt and decrypt information exchanged during the SSL session and to verify its integrity (that is, to detect any changes in the data between the time it was sent and the time it is received over the SSL connection).

The consumer computer 102 sends a message to the payment authorization server 104 informing it that future messages from the consumer computer 102 will be encrypted with the session key. It then sends a separate (encrypted) message indicating that the consumer computer 102 portion of the handshake is finished. The payment authorization server 104 sends a message to the consumer computer 102 informing it that future messages from the payment authorization server 104 will be encrypted with the session key. It then sends a separate (encrypted) message indicating that the payment authorization server 104 portion of the handshake is finished. The SSL handshake is now complete and the session begins.

The consumer computer 102 and the payment authorization server 104 use the session keys to encrypt and decrypt the data they send to each other and to validate its integrity. This is the normal operation condition of the secure channel. At any time, due to internal or external stimulus (either automation or user intervention), either side may renegotiate the connection, in which case, the process repeats itself.

SSL is a slow process because of the back and forth negotiation and compute intensive asymmetric encryption. SSL generally bogs down a website, and it is best to minimize its use on a website.

3C. Certificate Stores

The consumer computer 102 and the payment authorization server 104 hold their certificates in a certificate storage area called certificate stores. Each browser on the consumer computer 102 (and some software on the payment authorization server 104) has its own certificate store. The personal certificate store stores the private keys and certificates for client authentication (i.e. payment authorization certificate 700). The root CA certificate store and intermediate CA certificate store each store the trusted CA certificates for SSL. The most common certificates issued by global CA's are preinstalled in the root CA certificate stores and intermediate CA certificate stores of both Netscape Navigator and Internet Explorer.

3D. Automatic Enrollment Software

All versions of Microsoft Windows since Windows 98 Second Edition have sophisticated cryptography, certificate request, and certificate installation software incorporated into both the operating system and individual browsers. This software includes versions of cryptographic service providers that utilize all of the major symmetric encryption algorithms, hash algorithms, and asymmetric encryption components. The software can be scripted on the client side using JavaScript or VBScript to request and install a payment authorization certificate 700 without user intervention, or additional software downloads. The payment system 100 uses this automatic enrollment software on the consumer computer 102.

The payment system 100 uses the cryptographic concepts in the following ways. All communications of sensitive information between the consumer computer 102 and the payment authorization server 104 are secured using SSL employing both public-key and symmetric-key encryption. The SSL communications in payment system 100 typically use RSA as the public key algorithm and typically can use DES, Triple DES, RC2, or RC4 as the symmetric-key algorithm. The payment authorization server 104 is SSL-enabled by the installation of a typical server authentication certificate 600. The consumer computer 102 is SSL-capable, and can participate in this SSL communication. A public key and private key pair is owned by the consumer computer 102. The public key is stored in a certificate signing request that is generated along with the private key-public key pair using automatic enrollment software on the consumer computer 102.

The certificate signing request is submitted over a secure SSL connection to the trusted CA 118 using the formats shown in FIGS. 1 and 7. Once signed and issued by the trusted CA 118, the payment authorization certificate 700 is installed on the consumer computer 102 using automatic enrollment software. The private key and the payment authorization certificate 700 are stored on the consumer computer 102 in the browser's personal certificate store. The payment authorization certificate 700 is presented along with a digital signature from the private key as proof of identity in the SSL communication with the payment authorization server 104. Included in the payment authorization certificate 700 is a consumer numeric ID 707 and a consumer encryption key 708 for encrypting payment information.

When opening a new payment account for the consumer computer 102, the trusted source 106 verifies the identity of the consumer computer 102, and then redirects the consumer computer 102 to payment authorization server 104 over a secure SSL connection. The redirection includes a hash of a secret password shared between the trusted source 106 and the payment authorization server 104. The redirection also includes the payment account information owned by the consumer computer 102 and verified by trusted source 106. The payment authorization server 104 identifies the consumer computer 102 via SSL client authentication, validates that the source of the request is the trusted source 106 by using the hash value from the trusted source 106, and then uses the consumer encryption key 708 found on consumer computer's 102 payment authorization certificate 700 to encrypt payment information using Rijndael encryption. The encrypted payment information 122 is stored at the payment authorization server 104 using the consumer numeric ID 707 as a reference.

When requesting a payment, an SSL connection is started that verifies the identities of the consumer computer 102 and the payment authorization server 104. The consumer encryption key 708 is read from the consumer computer's 102 payment authorization certificate 700. The consumer numeric ID 707 is used to identify the encrypted payment account information 122 owned by the consumer computer 102 that is stored at the payment authorization server 104. The consumer encryption key 708 is used to decrypt the payment account information and establish payment account ownership because only the value of the consumer encryption key 708 can decrypt the corresponding payment accounts stored at the payment authorization server 104.

IV. Payment Authorization Methods

In general, payment authorization servers are those that perform a payment authorization method, as illustrated in FIGS. 2 to 5, by which payment can be authorized from one person over the payment system 100 (see FIG. 1). The payment authorization server 104 relies on the payment authorization certificate 700 that is an immutable form of the public key and identifying information. The payment system 100 identifies an unknown person by the use of a private key and a public key. The private key is held in secret and is used to digitally sign a communication that includes the payment authorization certificate 700 containing the public key. The payment system 100 identifies the owner of the public key by the presentation of the digital signature and the payment authorization certificate. The payment authorization certificate 700 can be transferred from the consumer computer 102 to the payment authorization server 104. The payment authorization certificate 700 is configured to store the consumer numeric ID 707 and the consumer encryption key 708.

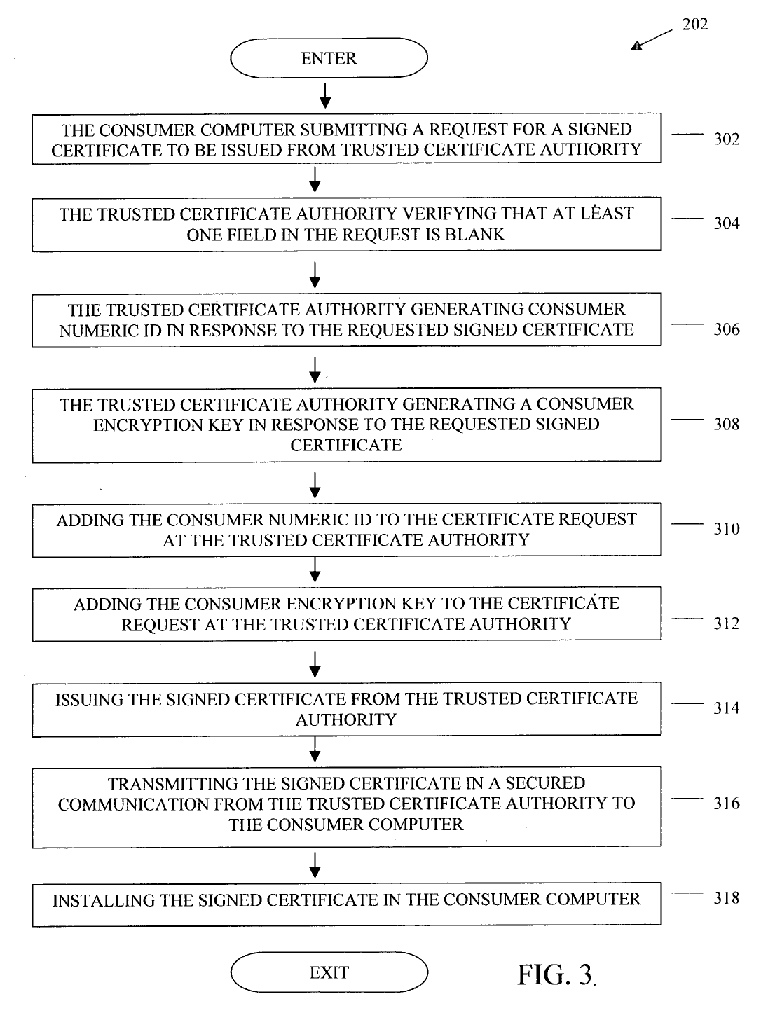

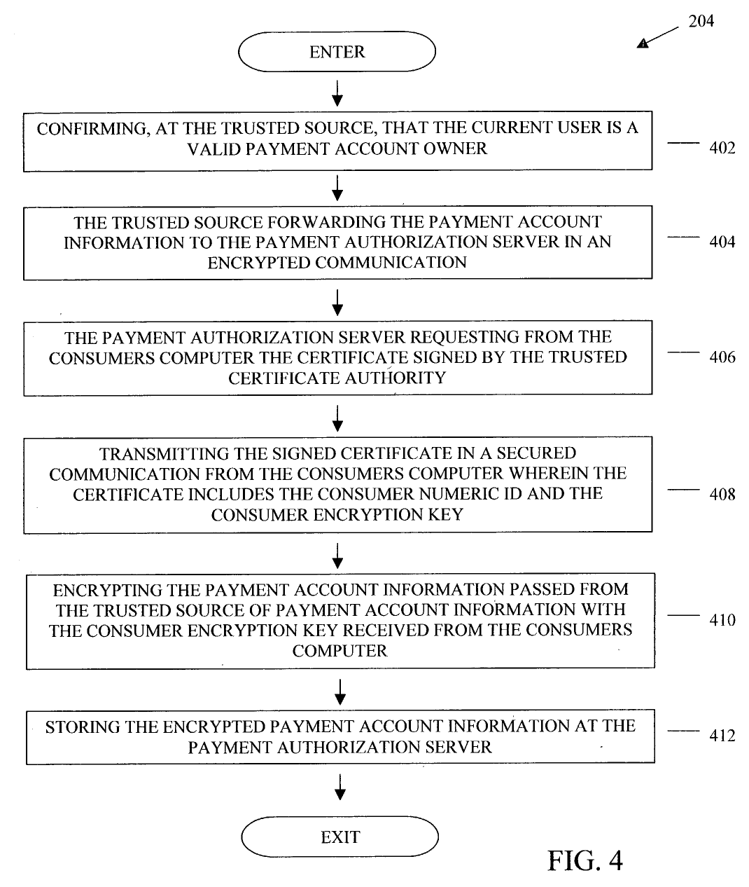

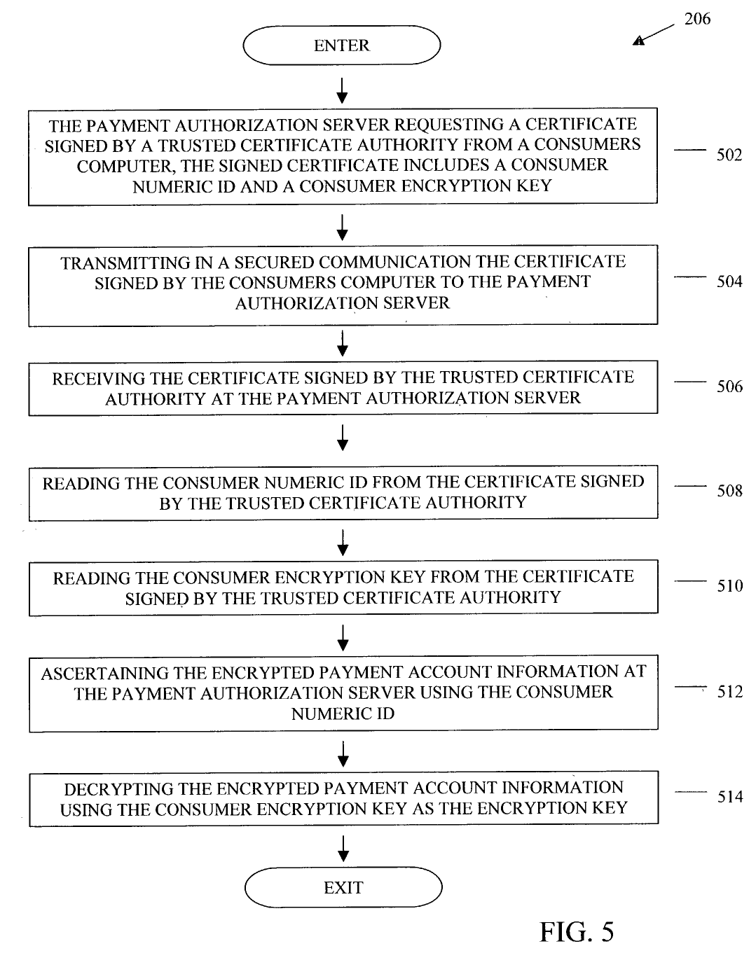

FIGS. 2 to 5 illustrate certain aspects of one embodiment of the payment authorization server 104 that provides for improved payment authorization between the consumer computer 102 and the payment authorization server 104. FIG. 2 illustrates one generalized embodiment of payment authorization method 200 performed by the payment system 100 as shown in FIG. 1. The payment authorization method 200 starts with step 202, in which a new user account corresponding to a new consumer associated with the private key and payment authorization certificate 700 is created and installed on the consumer computer 102. Step 202 is described more fully relative to FIG. 3. The payment authorization method 200 continues to step 204 in which a new payment account is created for the consumer within the payment system 100. Step 204 is more fully described relative to FIG. 4. The payment authorization method 200 continues to step 206 in which the payment authorization server 104 receives authorization from the consumer computer 102 to withdraw funds from the new payment account owned by the user of the consumer computer 102. Step 206 is more fully described relative to FIG. 5. Step 206 ends with the authorization of the payment account owner. Multiple steps occur after Step 206. Some of these steps include ensuring sufficient funds at the consumer's new payment account, charging the payment account, transferring funds from the payment account bank to the vendor's processing bank, and transferring funds from the vendor's processing bank to the vendor's bank. These steps are in addition to payment system 100, and are not included here.

4A. New User

FIG. 3 shows one embodiment of the create a new user method 202, previously shown in FIG. 2. The create a new user method 202 starts with step 302 in which the consumer computer 102, as shown in FIG. 1, submits the request for a signed payment authorization certificate 700 to trusted certificate authority (trusted CA) 118 referenced relative to FIG. 1. The certificate signing request submission includes: generating a private-public key pair at the consumer computer 102, including the public key in the certificate signing request at the consumer computer 102, transmitting the certificate signing request to the trusted CA 118 via network 105, and receiving the certificate signing request at the trusted CA 118.

The new user method 202 continues to step 304 in which the trusted CA 118 verifies that at least one field in the request is left blank. The new user method 202 continues to step 306 in which the trusted CA 118 generates the consumer numeric ID 707 for the new user. The new user method 202 continues to step 308 in which the trusted CA 118 generates the consumer encryption key 708. The new user method 202 continues to step 310 in which the consumer numeric ID 707 is added to the certificate signing request as an attribute.

A certificate signing request attribute is a name-value pair that adds a value to one of the fields of the certificate. The name of a certificate field can be indicated by a standardized name representative of the field or a standardized object identifier representative of the field. For example, the common name field of the certificate can be given a value of “John Doe” by adding the following attribute to the certificate signing request, “commonname:John Doe”.

The new user method 202 continues to step 312 in which the consumer encryption key 708 is added to the certificate signing request as an attribute. Steps 310 and 312 use attributes corresponding to a field or fields of the payment authorization certificate 700 where the payment authorization server 104 expects to find the values of the consumer numeric ID 707 and the consumer encryption key 708. The new user method 202 continues to step 314 in which the trusted CA 118 issues the signed payment authorization certificate 700 containing the consumer numeric ID 707 and the consumer encryption key 708. The new user method 202 continues to step 316 in which the signed payment authorization certificate 700 is transmitted in a secured communication from the trusted CA 118 to the consumer computer 102 via network 105. The signed payment authorization certificate 700 is installed in the consumer computer 102 in step 318. The consumer encryption key 708 is only retained at the trusted CA 118 temporarily for addition to the certificate signing request. At the completion of new user method 202, the value of the consumer encryption key 708 is not retained at the trusted CA 118.

The private key and public key (the public key is contained within the payment authorization certificate 700) prove payment account ownership. The consumer computer 102 does not by itself prove payment account ownership. The private key and the payment authorization certificate 700 of the consumer computer 102 indicate the new user in new user method 202 and the payment account owner in new payment account method 204. One alternative embodiment of new user method 202 allows the private key and payment authorization certificate 700 of the consumer computer 102 to be transferred to a different computer using a standard export/import routine. The preferred embodiment is that the private key is protected to prevent its unauthorized use by someone operating the consumer computer 102 or any other device on which the private key resides by a person that is not the true payment account owner. In one embodiment, the private key is protected by the browser using a password. In an alternative embodiment, the private key is protected by a biometric input device that reads the consumer's fingerprint and only grants access to the private key to the true consumer.

In a traditional PKI (as opposed to the payment system 100), the typical certificate 600 represents a person or client in client authentication or a website or server in server authentication. The typical certificate 600 holds personal information such as company name, person's name or company username, etc. Great care is necessary to establish this personal identity because once the trusted CA issues a typical certificate 600 for the person, those entities that trust the CA, also trust the information on the typical certificate 600. The typical certificates 600 are retained at the CA, and can be revoked by the CA if necessary. Revoked typical certificates 600 are kept in a certificate revocation list (CRL). Entities accepting the trusted CA's typical certificates 600 can check a CA's CRL before deciding whether to trust a presented typical certificate 600. When presenting the typical certificate 600 as identity, the digital signature from the private key is also presented to prove ownership of the identity.

The payment authorization certificate 700 is novel and different from the typical certificate 600 in that the consumer encryption key 708 and a reference for the consumer encryption key 708 (known as the consumer numeric ID 707) are included in the payment authorization certificate 700 which is employed in a PKI. The payment authorization certificate 700 is further novel because the payment authorization certificate 700 contains no personal or financial information of its owner (the operator of the consumer computer 102). New user method 202 is novel because no background check is made to identify the owner of the payment authorization certificate 700 before issuing the payment authorization certificate 700. New user method 202 is further novel because the certificate issued by the trusted CA 118 is not retained at the trusted CA 118 or anywhere else accessible on network 105.

The consumer encryption key 708 acts as a fingerprint. It is not necessary to know to whom the fingerprint belongs, just that this fingerprint can be presented in a payment authorization certificate 700 with the owner of the certificate assured by the presentation of the digital signature from the private key corresponding to the public key in the payment authorization certificate 700. This fingerprint is used to mark and mask payment account information in new payment account method 204. This fingerprint is used to ascertain payment account information and authorization to use the payment account information in authorization method 206.

4B. New Payment Account

FIG. 4 shows one embodiment of new payment account method 204, such as illustrated in FIG. 2 as described above. The purpose of new payment account method 204 is to set up a new payment account for a particular consumer within payment system 100. The new payment account method 204 starts with step 402 in which the trusted source 106 confirms that the current user is a valid payment account owner.

Trusted source 106 can make this confirmation in a number of ways. One alternative embodiment uses a retail website as the trusted source 106. The retail website checks guideline parameters to determine if the customer currently logged into their website is most probably the payment account owner. An example guideline would be regular purchases over the last year. If the current customer has used the payment account on record with the retail website regularly to make purchases, there is a high probability that the current customer is truly the payment account owner. An alternative embodiment uses the payment account bank's website as the trusted source 106. Another alternative embodiment uses a transaction verification website (the payment authorization server 104 can serve as a transaction verification website as an example) as the trusted source 106.

The transaction verification website makes a series of small deposits and/or withdrawals from the payment account. The owner of the payment account verifies their account ownership by entering the exact amounts of the transactions at the transaction verification website. One alternative embodiment uses a card-reader station that is connected to the Internet as trusted source 106. The consumer swipes their payment account card (such as a credit card or debit card) through the card-reader. In this embodiment the payment authorization certificate 700 and corresponding private key of the consumer computer 102 need to be exported from consumer computer 102 and temporarily imported onto the card-reader station. The payment authorization certificate 700 and corresponding private key are subsequently removed from the card-reader station after new payment account method 204 completes.

The new payment account method 204 continues to step 404 in which the payment account information from the trusted source 106 is forwarded to payment authorization server 104. The new payment account method 204 continues to step 406 in which the payment authorization server 104 requests a payment authorization certificate 700 signed by the trusted CA 118 and proof of ownership of the payment authorization certificate 700 by a digital signature from the private key found on the consumer computer 102 that corresponds to the public key in the payment authorization certificate 700. The new payment account method 204 continues to step 408 in which the digital signature and the payment authorization certificate 700 containing consumer the numeric ID 707 and the consumer encryption key 708 are transmitted in a secured communication from the consumer computer 102 to the payment authorization server 104 via the network 105. The new payment account method 204 continues to step 410 in which the payment account information passed from the trusted source 106 is encrypted using the consumer encryption key 708. The new payment account method 204 continues to step 412 in which the encrypted payment account information 122 is stored at the payment authorization server 104. This step establishes the new payment account for the consumer at the payment authorization server. By successful verification, the consumer computer 102 can use the payment account to make purchases.

In a traditional payment system (as opposed to the payment system 100), payment information is retained at a retail website where it can be accessed by its repeat customers. Retention of this information represents a liability. Internal attacks from employees of the company or external attacks from hackers can compromise the payment information. In more secure traditional payment systems, payment information is encrypted before it is stored in the payment system. This measure only protects against simple attacks directly on the data. The payment system itself including web server and/or payment authentication server need to be able to access the payment information in decrypted form, so they know how to decrypt the stored payment information. An unauthorized observer needs only to access through these areas instead of directly accessing the data. Further, traditional PKI systems have the complexity of setting up and maintaining the connection between typical certificates 600 and payment account owners. This complexity precludes its use in a payment system. Each consumer would have to be identified by an agent as the payment account owner and set-up with a typical certificate 600 for that establishes payment account ownership before they could use the payment system.

New payment account method 204 is novel and different from a traditional payment system in that the encrypted payment account 122 is the only record of the consumer's payment information. To decrypt the encrypted payment account 122 requires the consumer encryption key 708. The consumer encryption key 708 only resides on the consumer computer 102. The payment account information is secured from both internal and external attacks. New payment account method 204 is further novel in that, by having no requirements on issuing payment authorization certificate 700 to a consumer in new user method 202, new payment account method 204 can make use of the cryptographic certainty of identification using digital signatures without requiring specific payment account ownership to be pre-verified.

4C. Payment Authorization

FIG. 5 shows one embodiment of payment authorization method 206 such as illustrated in FIG. 2. The authorization method 206 of FIG. 5 follows the new user method 202 and the new account method 204, as illustrated in FIGS. 3 and 4, respectively. The authorization method 206 commences with step 502 in which the payment authorization server 104 requests from the consumer computer 102 the payment authorization certificate 700 which is signed by the trusted CA 118. The payment authorization certificate 700 includes the consumer numeric ID 707 and the consumer encryption key 708. The authorization method 206 continues to step 504 in which the consumer computer 102 transmits the payment authorization certificate 700 to the payment authorization server 104 over a secure communication via the network 105. The authorization method 206 continues to step 506 in which the payment authorization server 104 receives the payment authorization certificate 700. The authorization method 206 continues to step 508 in which the payment authorization server 104 reads the consumer numeric ID 707 from the payment authorization certificate 700 passed from the consumer computer 102. The authorization method 206 continues to step 510 in which payment authorization server 104 reads the consumer encryption key 708 from the payment authorization certificate 700 passed from the consumer computer 102. The authorization method 206 continues to step 512 in which the payment authorization server 104 ascertains the encrypted payment account information 122 using consumer the numeric ID 707. The authorization method 206 continues to step 514 in which the payment authorization server 104 decrypts the encrypted payment account information 122 using the consumer encryption key 708 as the encryption key. The payment account information is in the form of a delimited string in certain embodiments. In these embodiments, the payment account information is parsed from the delimited string after step 514.

In a traditional payment system (as opposed to the payment system 100), payment information is retained at a retail website where it can be accessed by its repeat customers. Gaining use of this information only requires a password. Passwords are notoriously poor forms of authentication. Passwords can be stolen. Passwords can be guessed by learning simple information about a person. Each time a password is required for access, 38% of people (according to a survey by the Worldwide Fraud Prevention Network) use similar passwords to ones they have already used; meaning learning one of a consumer's password is essentially equivalent to gaining access to all areas that require passwords of the consumer.

Authorization method 206 is novel and different from a traditional payment system in that, by having no requirements on issuing payment authorization certificate 700 to a consumer in new user method 202, authorization method 206 can make use of the cryptographic certainty of identification using digital signatures for authorizing use of a payment account instead of a password. Authorization method 206 is further novel in that decrypting the encrypted payment account 122 requires the consumer encryption key 708. Presentation of a payment authorization certificate 700 with a consumer encryption key value that is not equal to the consumer encryption key 708 will not allow the encrypted payment account 122 to be decrypted. The combination of the use of a PKI's digital signatures, restricting access to the payment authorization certificates 700 signed and issued by the trusted CA 118, the password protecting the use of the private key on the consumer computer 102 (a 9 digit password for example), and the necessary decryption of the encrypted payment account 122 using the consumer encryption key 708 provides payment account ownership certainty equivalent to a card-swipe with a 9 digit PIN in a card-present sale. In addition, the payment account information is not exposed to risk of being stolen.

Although the invention has been described in connection with specific exemplary embodiments, it should be understood that various changes, substitutions, and alterations could be made to the disclosed embodiments without departing from the spirit and scope of the invention as set forth in the appended claims.

What is claimed is:

1. A certificate for use in a payment system, the payment system identifies an unknown person by the use of a private key and a public key, the private key is held in secret and is used to digitally sign and authenticate a payment using the public key, the payment system is in place to identify the owner of the public key by the presentation of the digital signature from a private key:
the certificate is an immutable form of the public key and identifying information, the certificate can be transferred from a consumer computer to a payment authorization server, the certificate is configured to store a consumer numeric ID and a consumer encryption key.

2. The certificate of claim 1, wherein the certificate is an X.509 certificate.

3. The certificate of claim 1, wherein the certificate is stored in a computer.

4. The certificate of claim 3, wherein the certificate is stored in a browser on the computer.

5. The certificate as in claim 1, wherein the consumer encryption key is used to encrypt payment information.

6. The certificate as set forth in claim 5, wherein the encrypted payment information is stored at the payment authorization server.

7. A method of establishing consumer identification information relating to a consumer computer in a payment system, the payment system including the consumer computer and a payment authorization server, the method comprising:
the consumer computer submitting a request for a signed certificate from a trusted certificate authority, wherein at least one of the fields is blank;
the trusted certificate authority verifying that at least one field in the request is blank;
generating consumer numeric ID at the trusted certificate authority in response to the requested signed certificate;
generating consumer encryption key at the trusted certificate authority in response to the requested signed certificate;
adding the consumer numeric ID to the certificate request at the trusted certificate authority;
adding the consumer encryption key to the certificate request at the trusted certificate authority;
issuing the signed certificate from the trusted certificate authority in response to the certificate request;
transmitting the signed certificate in a secured communication from the payment authorization server to the consumer computer; and
installing the signed certificate in the consumer computer.

8. The method of claim 7, further comprising storing the consumer numeric ID at the trusted certificate authority, wherein the consumer encryption key is not stored;

9. The method of claim 7, wherein when the consumer computer submits the request for the signed certificate, the consumer numeric ID and the consumer encryption key are stored in standardized fields in the certificate, further wherein the trusted certificate authority checks to ensure that the standardized fields are blank.

10. The method of claim 7, wherein the certificate authority is physically located within the payment authorization server.

11. The method of claim 7, wherein the certificate is an X.509 certificate.

12. The method of claim 7, wherein the consumer key is in the form of a hexidecimal string.

13. The method of claim 7, wherein the signed certificate is stored in the browser of the consumer computer.

14. The method of claim 10, wherein the browser generates the request for a signed certificate.

15. The method of claim 7, wherein the certificate is for use in a payment system, the payment system identifies an unknown person by the use of a private key and a public key, the private key is held in secret and is used to digitally sign and authenticate a payment using the public key, the payment system is in place to identify the owner of the public key by the presentation of the digital signature from the private key.

16. The method of claim 7, wherein the trusted certificate authority is an intermediate certificate authority whose certificate has been signed by the trusted certificate authority.

17. A method of creating a new payment account with encrypted payment information for a consumer computer at a payment authorization server using a trusted source of payment account information and a trusted certificate authority, the consumer computer including a certificate containing a consumer numeric ID and a consumer encryption key, the method comprising:
confirming, at the trusted source of payment account information, that a current user is a valid payment account owner;
the trusted source of payment account information forwarding the payment account information to the payment authorization server in an encrypted communication;
the payment authorization server requesting from the consumers computer the certificate signed by the trusted certificate authority;
transmitting the signed certificate in a secured communication from the consumers computer wherein the certificate includes the consumer numeric ID and the consumer encryption key;
encrypting the payment account information passed from the trusted source of payment account information with the consumers encryption key received from the consumers computer.

18. The method of claim 17, further comprising storing the encrypted payment account information at the payment authorization server, the storing is in relation to its consumer numeric ID [relational database] from the consumers certificate.

19. The method of claim 17, wherein the payment authorization server only accepts certificates signed by the trusted certificate authority.

20. The method of claim 17, wherein the certificate signed by the trusted certificate authority is an X.509 certificate.

21. The method of claim 17, wherein the payment account information to be encrypted is parsed into a standard format according to its payment account type.

22. The method of claim 17, wherein the certificate is for use in a payment system, the payment system identifies an unknown person by the use of a private key and a public key, the private key is held in secret and is used to digitally sign and authenticate a payment using the public key, the payment system is in place to identify the owner of the public key by the presentation of the digital signature from the private key.

23. The method of claim 17, wherein the trusted certificate authority is an intermediate certificate authority whose certificate has been signed by the trusted certificate authority.

24. The method of claim 17, wherein the trusted source of payment account information is physically located within the payment authorization server.

25. A method of a payment authorization server obtaining payment account information from a consumers computer for a purchase, the payment authorization server containing encrypted payment account information in relation to a consumer numeric ID, the consumers computer containing a consumer numeric ID and a consumer encryption key, and the consumer encryption key being the encryption key for the encrypted payment account information stored at the payment authorization server, the method comprising:
the payment authorization server requesting a certificate signed by a trusted certificate authority from a consumers computer, wherein the signed certificate includes a consumer numeric ID and a consumers encryption key;
transmitting in a secured communication the certificate signed by the trusted certificate authority from the consumers computer;
receiving the certificate signed by the trusted certificate authority at the payment authorization server;
reading the consumer numeric ID from the certificate signed by the trusted certificate authority;
reading the consumer encryption key from the certificate signed by the trusted certificate authority;
ascertaining the encrypted payment account information from the payment authorization server using the consumer numeric ID;
decrypting the encrypted payment account information using the consumer encryption key as the encryption key.

26. The method of claim 25, further comprising parsing payment account information from the decrypted payment account information.

27. The method of claim 25, wherein the certificate signed by the trusted certificate authority is an X.509 certificate.

28. The method of claim 25, wherein the payment authorization server only accepts certificates signed and issued by the trusted certificate authority.

29. The method of claim 28, wherein the trusted certificate authority is an intermediate certificate authority whose certificate has been signed by the trusted certificate authority.

30. The method of claim 25, wherein the certificate is for use in a payment system, the payment system identifies an unknown person by the use of a private key and a public key, the private key is held in secret and is used to digitally sign and authenticate a payment using the public key, the payment system is in place to identify the owner of the public key by the presentation of the digital signature from the private key.
